(19) United States
(12) Patent Application Publication
(10) Pub. No.: US 2011/0260480 A1
(43) Pub. Date: Oct. 27, 2011

(54) CLAMPING HEAD FOR AN EARTH-DRILLING SYSTEM

(76) Inventor: Dietmar Scheider, Voerde (DE)

(21) Appl. No.: 12/918,234

(22) PCT Filed: Feb. 27, 2009
(86) PCT No.: PCT/EP09/01414

§ 371 Date: Jan. 1, 2011

(30) Foreign Application Priority Data
Mar. 5, 2008 (DE) 10 2008 012 729.9

(51) Int. Cl. B66C 1/42; E21B 7/20

(52) U.S. Cl. 294/102.2

(57) ABSTRACT

The invention relates to a clamping head for an earth-drilling system comprising a hollow shaft (3) through which a drill pipe (9) can be guided, wherein a sleeve (1) is arranged coaxially on the hollow shaft (3) in such a way that it can move relative thereto, said sleeve having at least one widening end region (1b), in particular a downwardly widening end region which particularly widens in a conical shape, and wherein at least two clamping jaws (2) which can move radially with respect to the hollow shaft (3) are mounted in the hollow shaft (3) and/or on the sleeve (1), said clamping jaws being provided at their radially outer end with run-on surfaces (2b) interacting with the widening end region (1b), such that the clamping jaws (2) can be pressed radially inward as a result of the end region (1b) sliding over them and form a first clamping mechanism for a drill pipe (9), in particular such that a torque can be transmitted between the hollow shaft (3) and drill pipe (9) as a result of an interaction between the clamping jaws (2) and drill pipe (9), wherein a second clamping mechanism is provided in the hollow shaft (3) and can be used to secure a drill pipe (9) in the axial direction, in particular in order to draw a drill pipe (9) from the ground in the axial direction.

The invention relates to a clamping head for an earth-drilling system having a tube shaft through which a drill pipe can extend, a sleeve coaxially surrounding and shiftable along the tube shaft and having at least one end section that flares, in particular downward and frustoconically, the tube shaft and/or the sleeve supporting at least two jaws radially displaceable with respect to the tube shaft and having, at their radial outer ends, cam faces engageable with the flared end section so that pressing the end section against the jaws shifts them radially inward and forms a first clamping mechanism for a drill pipe, in particular so that by mutual engagement of the jaws and the drill pipe a moment of rotation can be transmitted between the tube shaft and the drill pipe.

It is thereby possible to displace the cited sleeve by a hydraulic actuator.

Clamping heads of this type are known in the prior art. In them, the outer, displaceable sleeve with the flared end section is also described as a clamping head bowl, because of its outer shape. Here, the flared end section can, as stated above, for example, be conical, such that in the conventional working position of such a clamping head, the flared end section of the sleeve is at the lower end of this sleeve, so that displacement of the clamping jaws occurs radially inward into the tube shaft when the sleeve is pushed downward on the tube shaft and this way the end section that conically flares downward is pushed further and further over the ends of the clamping jaws.

The clamping jaws mentioned here can thereby engage through apertures in the tube shaft that extend radially through the wall of the tube shaft.

The jaws can thereby be shiftable on the tube shaft as well as on the sleeve or on both elements. It is known in one embodiment that the section flared axially of the tube shaft is provided with elongated holes through which screws engage from the outside that are, at least in the lateral cross section, essentially vertically screwed into the cam faces of the clamping jaws, in order to achieve a loose connection between clamping jaws and sleeve. Thus, the clamping jaws are, in particular at the conically widened end section, loosely mounted in the sleeve and can move axially within the elongated holes relative to the sleeve, so that the sleeve can be pushed over the clamping jaws.

If the clamping jaws together with the sleeve are pushed radially inward into the tube shaft, for example, by lowering the sleeve relative to the tube shaft, the inner surfaces of the clamping jaws that are turned toward the drill pipe can come in contact with it, as a result of which an operative connection can be achieved between clamping jaws and drill pipe. Such an operative connection can, for example, exist as a force closure and/or engagement and/or a frictional connection. Thus the possibility exists of transmitting torque between the tube shaft and the drill pipe, i.e. to thereby rotate the drill pipe in the earth so that the tube shaft is rotated.

In the prior art, separate devices are also known that make it possible to pull the drill pipe out of the earth again out of a bore that had been formed in the earth by the earth-drilling system. For such a devices, which is also called an elevator head, it is know in the prior art to provide it separately from a clamping head at the drill system of the type mentioned above.

Because of this separate unit, a drill pipe can be lifted by an earth-drilling system or the drill pipe can be rotated. The superimposition of both movements is not possible with the earth-drilling systems known in the prior art or this requires a significant control effort in order to coordinate the movements of both of the heads mentioned above.

It is the object of the invention to provide a clamping head for an earth-drilling system with which it is possible to also transmit torque when pulling a drill pipe out of the drill hole, in order to be able to simultaneously rotate the drill pipe during the lifting movement and to thus simplify the lifting of the drill pipe out of the earth, as due this rotation reduces adhesion between drill pipe and earth. It is also the object of the invention to further develop the clamping head so that the clamping jaws are moved safely when the sleeve is shifted and preferably also that damage to a drill pipe due to the clamping jaws is avoided.

In accordance with the invention, this problem is solved by a clamping head of the type mentioned above in which the tube shaft is provided with a second clamping mechanism that can fix the drill pipe axially, at least during a lifting movement.

In a first possible embodiment the second clamping mechanism just like the first clamping mechanism can be actuated by movement of the sleeve displaceable on the tube shaft. This has, for example, the advantage that only one actuator is required to displace the sleeve.

In a different embodiment the sleeve for actuating the first clamping mechanism by a first actuator, in particular a hydraulic actuator, is displaceable relative to the tube shaft, and the second clamping mechanism can be actuated by a second actuator separate from the first actuator, both actuators being in particular mounted on one side of a joint support. Thus, both clamping mechanisms can be operated independently of each other, for example, one after the other or simultaneously, for example, by synchronization from a master controller that controls the actuators. Thus, in both embodiments, the actuators can each comprise, for example, at least one, preferably several uniformly distributed cylinder-piston assemblies on the tube shaft.

A clamping head of this type according to both embodiments has the advantage in accordance with the invention that two different clamping mechanisms are provided in the same clamping head, one of the clamping mechanisms being optimally adapted to transmit torque between the tube shaft and the drill pipe and the other clamping mechanism can optimally adapted to transmit axial force to the drill pipe, in particular to pull the drill pipe out of the earth.

Because of the combination of both clamping mechanisms in one setup, the invention further has the advantage that with the same clamping head an axial as well as a rotational movement can be exerted on the drill pipe at the same time. In the first embodiment, this can occur, for example, in the absence of having to provide a special control for such, as both movements are coupled to each other.

In both embodiments in accordance with the invention the second clamping mechanism comprises at least two or preferably more—three to five—clamping elements each provided with a radial outer guide face that works together with a guide face inside the tube shaft, so that axial displacement of the clamping element in particular during a movement of the clamping element in the conventional working position of the clamping head downward causes radial movement, in particular inward. Such a guide face of a clamping element can, for example, be designed in the shape of a frustocone.

Thus, in the first embodiment, as mentioned above, the individual clamping elements of the second clamping mechanism are displaced when the sleeve mounted on the outside of the tube shaft is moved axially downward, in particular in the conventional working position. For this, a mechanical operative connection between the outer sleeve and the inner clamping elements is provided that can, for example, extend through the wall of the tube shaft.

In this way displacement of the sleeve on the outside of the tube shaft entrains the clamping elements mounted in the tube shaft in the same direction of movement at least in sections. According to the second embodiment, the clamping elements are separately actuated.

In both embodiments, a corresponding configuration of the respective guide faces of the tube shaft and the clamping elements ensures that during axial displacement, radial displacement of the clamping elements also takes place automatically, in particular so that these can be engage tightly around a drill pipe surrounded by the tube shaft.

The kinematic conversion of an axial displacement of the clamping elements into a simultaneous radial displacement is thus ensured when the guide faces that work together between the clamping elements and tube shaft are set at an incline relative to the central axis of the tube shaft, in particular when viewed in cross section, at an acute angle.

A positive fit between the clamping elements and a drill pipe can thereby also be achieved by contact faces provided at the clamping elements at their radial inner ends and fitting to a drill pipe with respect to shape, for example, also to the diameter of a drill pipe, so that these contact faces, for example, at least have a part-cylindrical surface and/or can also be adapted to a shoulder of the drill pipe, for example, a step at which the diameter of the drill pipe changes, in particular downwardly tapered.

Such an offset can also be formed at the shoulder or step, for example, by a rectangular step relative to the axis of the drill pipe or also by a conical step or perhaps different shapes. The contact faces of the clamping elements accordingly also have surfaces that are fit with such a shoulder or step so that a positive fit between the clamping elements and a drill pipe due to the contact of the clamping elements at a shoulder of this type or step allows an axial lifting force to be exerted on the drill pipe when the contact face abuts at the shoulder/step, without any slipping of the clamping elements axially relative to the drill pipe. The contact faces can be on a clamping element, preferably at the upper or the lower end thereof.

In order to obtain a corresponding guide face as counter surface for those guide faces at the respective clamping element, in a preferred embodiment, in particular, in both embodiments such a guide face is formed inside the tube shaft by a ring that protrudes radially inward, the inner periphery of which forms a tapered, in particular frustoconical surface that is coaxial to the central axis of the tube shaft, this frustoconical surface preferably tapering downward in the standard working position of the clamping head. Precisely due to the downward taper, a downward movement of the clamping elements within the clamping head causes a radial inward displacement of these clamping element when the guide face at the clamping element slides along the frustoconical surface of the ring.

The formation of a frustoconical surface on the inner ring inside the tube shaft has production advantages as such a frustoconical surface can be formed easily by an inner turning of a shaft. For example, a tube shaft can be made of a solid workpiece for this.

The radial outer guide faces of the clamping elements can further be designed as outer cone surface sections corresponding to the frustoconical outer surface.

Hence when frustoconical guide faces are provided on the clamping elements as well on at the projecting ring or they form a part of a frustoconical surface, there is only one certain position at which the respective guide faces of clamping element and ring come in contact with each other form-fit, as beyond this certain position, the diameters of the individual cone surfaces relative to the central axis of the tube shaft do not fit with each other.

In a preferred embodiment the guide faces of the clamping element and ring are complementary to each other in such a way that engagement between these guide faces increases with increasing engagement between the clamping elements and a drill pipe, i.e. in is particular then, when the clamping elements are pushed downward and thereby simultaneously inward.

Thus, the second clamping mechanism can be designed in such a way that at that moment when an optimal engagement exists between the clamping elements and a drill pipe, an optimal engagement between the corresponding guide faces is also created. In this way, forces are optimally transmitted between the surfaces by avoiding local pressures that are too high. This embodiment further has the advantage that in case engagement does not yet exist between the clamping element and the drill pipe or between the corresponding guide faces, these guide faces are not adjacent to each other extending over their entire surface area, but only selectively or linearly, so that friction between the guide faces is reduced in this position of the clamping elements.

The same design can also be provided between the guide faces of the clamping jaws of the first clamping mechanism and the conically flared end section of the outer sleeve. All previously mentioned embodiments, with respect to the design of the guide faces between the clamping elements of the second clamping mechanism and the frustoconical surface of the ring, analogously also apply to the clamping jaws of the first clamping mechanism and the frustoconical, flared end section of the sleeve.

In a different possible embodiment of both embodiments, the inner surface of the frustoconical end section of the sleeve that flares downward has slots, in particular slots that are elongated vertically and that have a flat slot base. Thus, this slot base can be in operative connection directly or indirectly by an intermediate element with flat cam faces of the clamping jaws of the first clamping mechanism. In contrast to frustoconical operative surfaces, this embodiment has the advantage that greater forces can be transmitted by the larger surfaces.

The base of a slot acts directly upon a flat cam face of a clamping jaw, or in a preferred embodiment, a guide element is mounted in the slot into which a clamping jaw is inserted with its end that has a flat cam face. The guide that was mentioned above relative to the prior art by screws and elongated holes can thus be omitted, and in addition to the advantage of the guide, be applied to the transmission of greater forces. A guide element of this type that acts as an intermediate element can, for example, be U-shaped with undercut profile brackets, i.e. the inner free width between the profile brackets is smaller in the upper section than in the lower section near the floor of the U-shape.

Thus, the guide can be formed by slots in the two lateral surfaces of a clamping jaw at the end with the cam face parallel to the flat cam face, with which flanges provided at one guide element, in particular the part of the profile brackets that is not undercut, engage.

In a further preferred embodiment a clamping element is displaceable axially on a bolt that extends parallel to the tube shaft axis and engages through a clamping element or a flange that is mounted on it that projects radially outward. This has the advantage that several clamping elements each have a guide and can only move along this guide axially inside the tube shaft.

Thus, for example jamming of the clamping element relative to the drill pipe is avoided. In order to make possible, in addition to a guided axial movement, radial movement, in particular inward, such a bolt is engaged through a radially throughgoing aperture of the clamping element or its cited flange that for example, is a radially elongated hole. Thus, during a movement of the clamping element axially, such can be guided axially to the bolt guided along such, but also move simultaneously perpendicular to the extension of the bolt radially.

As mentioned above, in accordance with the invention in a first embodiment the clamping elements are actuated by movement of the outer sleeve. To do this, an operative connection from inside the tube shaft to the outer sleeve can be provided. In a preferred embodiment, the clamping elements are displaceable axially by an actuation element located inside the tube shaft, in particular in the direction of increasing engagement relative to the drill pipe such that the actuation element is connected with the sleeve mounted on the outer of the tube shaft by at least one radial bar extending through a recess in the tube shaft.

In the second embodiment, the clamping elements are displaceable axially by at least one actuation element located inside the tube shaft, in particular in the direction of increasing engagement, the at least one actuation element being connected with a pressure ring surrounding the sleeve by at least one radial bar that extends through the aperture in the tube shaft, the one bar being in particular displaceable in an aperture axially of the tube shaft.

The pressure ring can to this end preferably be provided with in particular an upper cam face on which the second actuator, in particular the hydraulic cylinder of the second actuator, is supported by ball and/or roller bearings. Thus, the tube shaft and the pressure ring can be rotated relative to an actuator.

In order to make this possible, in the second and in particular also in the first embodiment, the first actuator or in the first embodiment the sole actuator, in particular, hydraulic cylinder of this actuator, can be connected with a ring surrounding the sleeve and supported by the sleeve in one axial direction as well as also in the opposite axial direction by ball and/or roller bearings, in particular with the ball and/or roller bearing surrounded by two collars surrounding the sleeve. Thereby, the compressive or traction forces can be transmitted to the sleeve by different bearings, i.e. in particular one bearing or a group of bearings can be provided for compression and the other for traction.

In both embodiment actuator types, an aperture provided in the tube shaft is elongated axially of the tube shaft so that during movement of the sleeve or a pressure ring axially, a bar that extends radially through such an aperture is also displaceable axially in its guide aperture. Thus, movement of a sleeve or a pressure ring on the outside of the tube shaft can be transmitted into the tube shaft, because the actuation element that is connected by the bars moves together with the sleeve. Movement of the actuation element can thus be transmitted to the clamping elements in various ways, for example by an actuation element that acts indirectly or directly upon a clamping element but also by an actuation element that acts indirectly upon a clamping element through intermediate elements, as will be explained later.

Hence in a specially preferred embodiment independent of the actuation element is annular and surrounds a drill pipe, and the clamping elements can be displaced simultaneously by this annular actuation element.

Further, the bolts mentioned above, along which the clamping elements move, are mounted on the actuation element. For example, they can be secured a screw connections and furthermore the bolts project into in guide bores on the ring formed in the tube shaft for the formation of the frustoconical guide face section. The bolts are thus located at a spacing from the central axis around this axis, in particular at a uniform angular spacing, just like the clamping elements that are displaceable on them.

In a further preferred embodiment, one clamping element, in particular each clamping element, in the tube shaft can be displaceable in the direction of increasing engagement and thus in particular in a downward direction with respect to the conventional working position counter to a reset force.

Such a reset force can, for example, be exerted by a compression spring, in particular one that is of the type that is braced at one end, in particular on the bottom face of the clamping element and with at its other end, in particular on the top face of the annular section mentioned above. Such a compression spring can also surround one of the bolts that was mentioned above.

Such a resetting force can also be generated by a compression spring whose one end is braced directly or indirectly on a ring at an inner shoulder of the tube shaft that is juxtaposed with the frustoconical surface, and whose other end is braced directly or indirectly on a ring at a radially overhanging upper section of the clamping element, in particular from below.

Movement of the clamping elements in the direction of increasing engagement against a reset force has the advantage that the clamping element can be pressed axially against a shoulder that is formed on a drill pipe or step by this reset force. Thus, at that moment at which the drill pipe releases a clamping element, this clamping element is pressed out of positive engagement with the guide faces by the reset force, i.e. for example, relative to the conventional working position, and it is pushed upward. The drill pipe is thus released from the clamping elements. A release of this type between drill pipe and clamping element can be achieved, for example, when a drill pipe after lifting by such a clamping head in accordance with the invention, is set on the ground and the clamping head moves downward relative to the drill pipe away from the shoulder of the drill pipe axially of the drill pipe.

Separation of the clamping elements radially away from a drill pipe toward the outside, can be additionally supported in a further development in that the clamping elements, in particular at their upper end, are each provided with an inner cam face that is, in particular, tapered frustoconical downward, by means of which in an operative connection with the corresponding cam faces located in the tube shaft, a clamping element can be displaced radially is outward during upward motion, in particular when the respective clamping element moves axially upward and hence the respective cam face enters into operative engagement.

The corresponding cam faces located in the tube shaft can, for example, be formed by an outer lower frustoconical surface, especially a downward tapered section of a pipe fastened coaxially in the tube shaft in the upper section. This pipe can, for example, be fastened to the tube shaft by a ring that is mounted on it or a collar or also bars, in particular at its inner upper section.

In a further preferred embodiment, especially in the case of the first embodiment of the actuator, an indirect effect of the actuation element on the clamping elements is ensured by at least one compression spring provided between the actuation element and each clamping element. As a result of this a force does not act directly between actuation element and clamping element, but that the force is applied through a compression spring. Beyond that, this has the advantage that for a certain specified axial path of motion, essentially the same force is always exerted onto the clamping element, determined by the spring constant of the compression spring depending on the spring deflection.

Such a compression spring can be located directly between actuation element and clamping element, or also in an especially preferred embodiment, such a compression spring is mounted between an actuation element and an intermediate element, for example, an intermediate ring positioned between the actuation element and the clamping element. In turn, such an intermediate ring contacts all clamping elements simultaneously. Accordingly, springs can be located between the ring surfaces that point to each other of intermediate ring and actuation element, for example, preferably at the positions at which the bolts mentioned above can extend starting at the actuation element through the intermediate ring and the clamping elements. Thus, each of these springs can, for example, surround a bolt.

An embodiment of this type has the special advantage in accordance with the invention that in the first embodiment of the actuator, a sleeve can be displaced axially relative to the tube shaft, whereby first due to the indirect effect of the actuation element by the compression springs, the clamping elements can be pushed into a engagement with a drill pipe, whereby after achieving this engagement between actuation element and clamping elements or actuation element and intermediate ring, an axial range of movement remains.

This axial range of movement thus happens when, upon reaching engagement, the compression springs are not yet completely compressed. Consequently, an axial range of motion remains that is determined by the compression of the compression springs achieved in engagement up to the maximum possible compression of the compression springs, for example, when their coils engage each other or a separate stop is provided. The design of the clamping head in accordance with the invention can consequently be of the type that because of this remaining range of movement, even when engagement is already present between the clamping elements and the drill pipe, the outer sleeve can continue to move axially in this is given range of movement until an operative connection between the clamping jaws of the first clamping device and the drill pipe is established. This functional locking can, for example, consist of a force closure and/or engagement and/or frictional locking between the clamping jaws of the first clamping device and the drill pipe.

Thus in the first embodiment of the actuator, during movement of the sleeve, in particular relative to the conventional working position axially downward, first a positive fit with respect to the axial fixation of the drill pipe is achieved with the second clamping mechanism, and after it is obtained, further movement the sleeve makes an operative connection between the clamping jaws of the first clamping device and the drill pipe, in order to hereby be able to transmit a moment of rotation.

In the two embodiments of the actuator at the lower end of the end of the sleeve that flares downward, in particular conically, an, in particular perforated ring is mounted that surrounds the tube shaft with its inner periphery and that surrounds the end section with a collar that stands upward. Hereby, stabilization of the sleeve is achieved that can otherwise have the tendency to splay when the compression forces are applied by the clamping jaws. This splaying can be prevented by the stabilizing ring.

Thus, such a clamping head in accordance with the invention makes it possible when lifting the drill pipe—in addition to the traction exerted for this purpose out of the earth—to also simultaneously rotate the pipe because of the possibility of the transmission of torque, and to thus decrease adhesion between the drill pipe and the earth, which significantly simplifies the lifting process. The clamping jaws of the first clamping mechanism can thus, for example, have the shape of the surface that is working together with the drill pipe, which creates a good operative connection. For example, the surface can have a surface structuring and/or preferably a coating that acts as frictional lining. Such a coating can, for example, have particles, for example sand, diamonds, etc. that improve the operative connection. Thus, the force can be applied to the drill pipe over a large surface, as a result of which local damage is avoided.

In the case of a reverse movement of the sleeve, i.e. relative to a normal working position from the bottom to the top, in the first embodiment of the actuator—thus in reverse sequence—first the operative connection between the clamping jaws and the drill pipe, in the case when the drill pipe hangs in the clamping head, the engagement between the clamping elements of the second clamping device and the drill pipe first remains intact, as the drill pipe—via its shoulder/step that was described above—bears on the clamping element with the force of its weight and thus these are now, instead of loaded by the sleeve/actuation element, loaded via the drill pipe axially downward in the direction of gravity, so that the engagement remains intact and self-locking.

Only as mentioned above, in the case when the drill pipe releases the clamping elements, for example, is set on the ground, the clamping head sinks relative to the drill pipe, as a result of which engagement between the drill pipe or the shoulder and the clamping elements is cancelled and the clamping elements are pressed axially upward due to the spring load and thus release the drill pipe. In a second embodiment of the actuator, the separate actuator is actuated in order to create the engagement of the clamping elements or to release it.

In the device in accordance with the invention in the two embodiments of the actuator the second clamping mechanism is located, relative to the conventional working position of the clamping head, above the cited first clamping mechanism. Likewise, it is possible to also reverse this configuration.

A preferred embodiment of the invention is shown in the following figures. Therein:

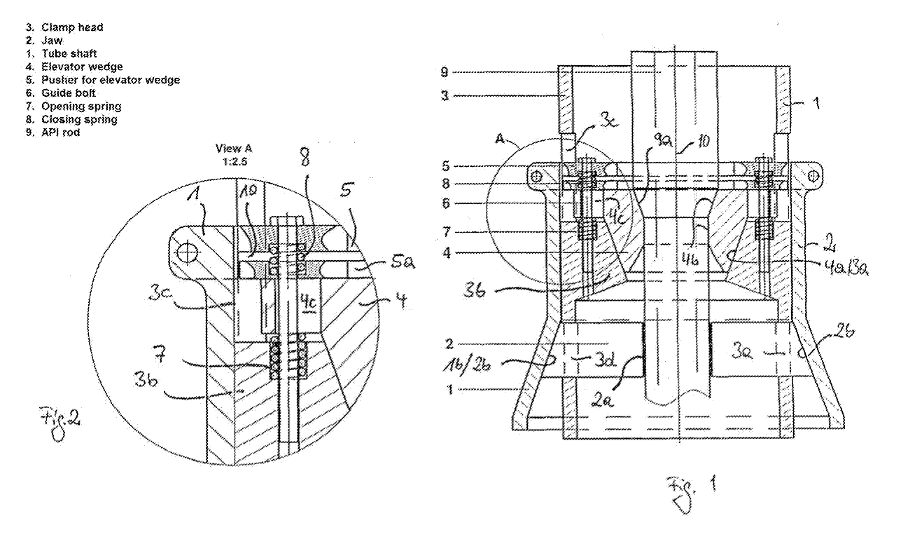

FIG. 1 is a cross section through a clamping head in accordance with the invention of a first embodiment of the actuator;

FIG. 2 is a detail view of the spring assembly of FIG. 1;

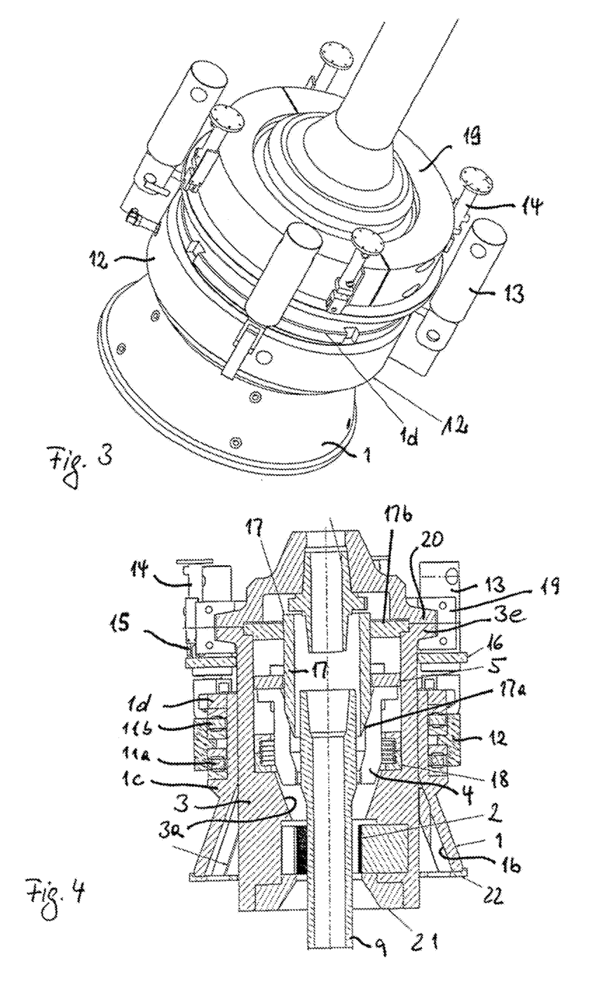

FIG. 3 is a perspective view of a clamping head of the second embodiment of the actuator;

FIG. 4 is a section through the clamping head according to FIG. 3;

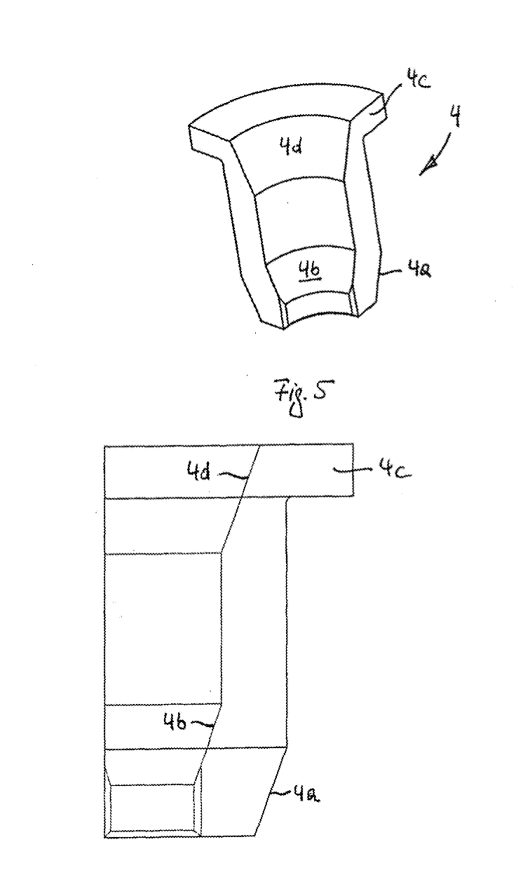

FIG. 5 is views of a clamping element;

FIG. 6 is a view showing only a tube shaft;

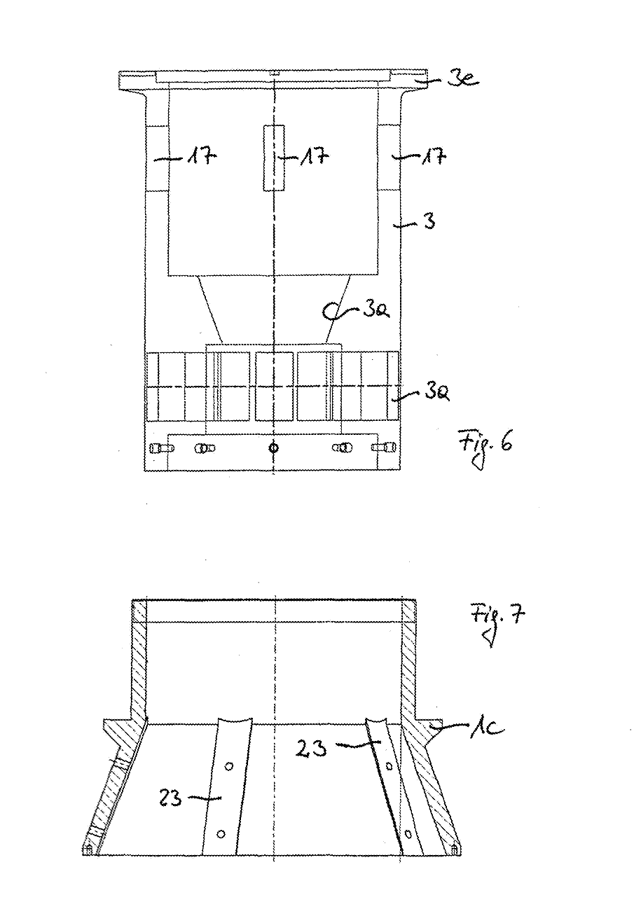

FIG. 7 is a view showing only a sleeve;

FIG. 8 is a view showing only a clamping jaw of the first clamping mechanism;

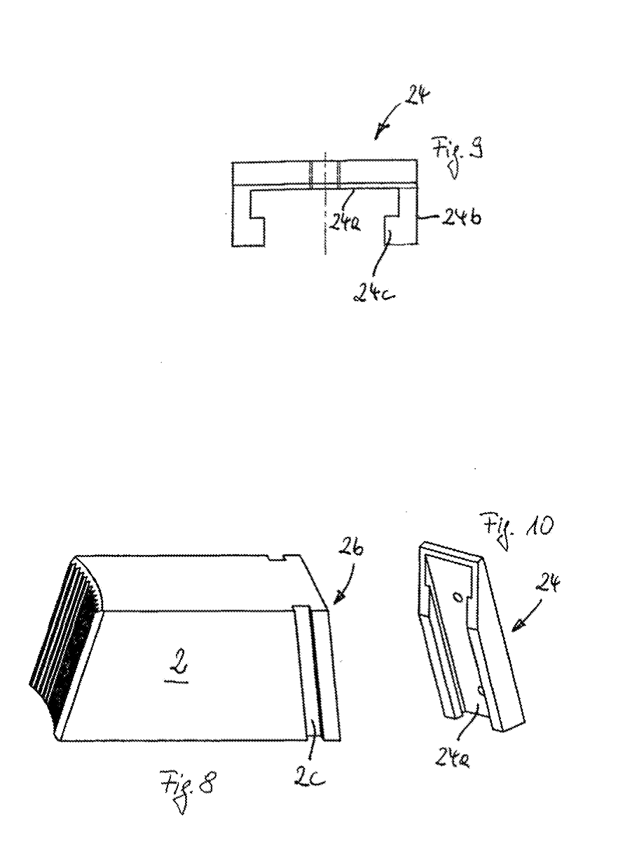

FIGS. 9 and 10 are views of the guide element for a clamping jaw according to FIG. 8.

In a side sectional view, FIG. 1 shows a clamping head in accordance with the invention of the type described in general above as a first embodiment of the actuator. A sleeve 1 mounted coaxially and axially displaceably on a tube shaft 3 has a lower end that flares frustoconically downward in this embodiment.

The tube shaft is formed near its lower end with radially throughgoing apertures 3d through extend radially extend clamping jaws 2 whose inner faces 2a fit to, and frictionally grip a drill pipe 9 when these jaws 2 are pressed radially all the way in. For example, the faces 2a can have a milled surface.

For this radial inward displacement, the jaws 2 have radial outer cam faces 2b that are complementary to an inner frustoconical face 1b of the lower end of the sleeve. This way, the faces can fit complementarily together, even if the radially inner faces 2a are forcibly engaged with the drill pipe, i.e. when the sleeve 1 is pressed downward with maximum force.

Further, a second clamping mechanism inside the tube shaft above the jaws 2 for example comprises several, here in particular four, clamping elements 4 distributed coaxially around a central axis 10 of the drill pipe 9 or the tube shaft 3, and having radially inner contact faces 4b designed to be fitted complementary to the drill pipe 9 or its shoulder 9a. At this shoulder 9a, the drill pipe 9 is tapered downward, in this case frustoconically.

The clamping elements 4 further have radially outer guide faces 4a extending at an acute angle to the central axis in this sectional view and further complementary to an inner guide face 3a of the tube shaft 3. This inner guide face 3a of the tube shaft 3 can be formed on a ring 3b that extends from the inner surface of the tube shaft 3 radially inward and has centered on the axis a throughgoing hole formed with a frustoconical inner surface tapering downward. Hence, the corresponding guide faces 4a and 3a of the clamping elements and the ring 3b of the tube shaft 3 are complementary to each other such that when pressed axially together as shown here between the clamping elements 4 and the drill pipe 9, there also results a very tight engagement between the radial outer guide faces 4a of the clamping elements and the inner frustoconical face 3a of the ring 3b.

Further, the clamping elements 4 are provided at their upper ends with outwardly directed flanges 4c through which extend guide bolts 6. The clamping elements can shift limitedly axially on these guide bolts and these radially projecting flanges 4c of the clamping elements 4 are formed with radially elongated holes so that during axial downward movement of the clamping elements 4 with the surfaces 3a and 4a sliding on each other, the clamping elements 4 can also move radially inward because of the clearance provided by these elongated holes.

Here as especially shown in FIG. 2, a special spring design can be seen in which the clamping elements 4 are each pressed downward against a spring force applied by so-called opening springs 7 in the direction of increasing gripping by the clamping elements of the drill pipe. The opening springs 7 are braced between the radial flanges 4c of the clamping elements 4 and the ring 3b, to which end the ring 3b has a blind hole. It can further be seen in this design that an element 5 provided as actuator for the clamping elements 4 is essentially annular, surrounds the drill pipe 9, and is connected by bars through apertures 3c with the outer sleeve 1. Between the actuation element 5 and the clamping elements 4 there is also an intermediate ring 5a that simultaneously bears from above on all the clamping elements 4.

Here, between the intermediate ring 5a and the actuation element 5, so-called locking compression springs 8 are provided that transmit movement of the actuation element 5 with the sleeve 1 indirectly via the springs 8 to the intermediate ring 5a and thence to the clamping elements 4. Thus, the clamping elements 4 are essentially pressed by the spring forces that are exerted axially downward by the compression springs 8 in the direction of increased gripping, not, however, by the forces that are exerted on the sleeve, for example by a hydraulic actuator or by the sleeve to the jaws 2. Here, it can be especially also seen in FIG. 2 that upon attaining maximum engagement between the jaws 4 and the drill pipe 9, as shown in FIG. 1, a gap 10 remains between the actuation element 5 and the intermediate ring 5a. This gap 10 represents a range of travel through which the sleeve 1, even on maximum engagement between the clamping elements 4 and the drill pipe 9, can be moved still further downward in order to thus press the jaws 2 with maximum force against the drill pipe 9. Thus first the drill pipe 9 is axially fixed by direct engagement of the shoulder 9a and the clamping elements 4, and because of the operative connection between the jaws 2 and the drill pipe 9, torque can be transmitted to it by rotation of the tube shaft 3. Thus, during lifting of the drill pipe 9, it can also be rotated, which eases the lifting process.

FIGS. 3 and 4 show a clamping head in accordance with the invention in a second embodiment in which the first and second clamping mechanism have separate actuators, here hydraulic cylinder-piston assemblies. Hence, in the following, essentially only those characteristics are described that are not present or were not cited with reference to FIGS. 1 and 2.

Here, the sleeve 1 has two collars 1c and 1d that are spaced above the flared lower end 1b, the collar 1c being made in one piece with the sleeve 1 and the collar 1d being formed by a ring that can be bolted to the sleeve. Both collars annularly engage respective bearings 11a and 11b, the bearing 11a pressing downward with a force (shearing force) and the bearing 11b pressing upward with a force (traction) on the sleeve. This force is applied to the sleeve by the bearings through a ring 12 surrounding the sleeve 1. In this way, the sleeve 1 can be rotated with the tube shaft 3, while the ring 12 that is coupled with the first actuator does not rotate. A first actuator is formed by a cylinder-piston assembly 13 mounted on the ring 12, for example, by piston rods distributed uniformly angularly around the ring.

The second actuator also comprises a cylinder-piston assemblies 14 distributed uniformly angularly around the clamping head and exerting via a ball and/or roller bearing 15 a force on a face [16a] of a pressure ring 16 connected by bars with the annular actuation element 5 through unillustrated apertures [17] in the tube shaft 3 so that movement of the pressure ring 16 is transmitted into the interior of the tube shaft 3.

This way, the actuation element 5 acts here directly from the top on the clamping elements 4, here in particular upon their radially outwardly projecting flanges 4c.

The clamping elements 4 used here are shown in detail in FIG. 5 with reference numbers that are the same as those used in FIGS. 1 and 2.

In contrast to the embodiment according to FIGS. 1 and 2, here each clamping element 4 also has a bearing surface 4d at its upper end that is of frustoconical shape and here acts together with corresponding faces 17a at the frustoconical lower end of a pipe 17 that is coaxially fixed in the tube shaft 3 by a ring 17b and surrounds the drill pipe 9.

FIG. 4 further shows a compression spring mechanism 18 for exerting force upon the clamping elements 4 in the opening direction. Here, a spring is inserted between a lower ring abutting an inner shoulder above the frustoconical inner surface 3a of the tube shaft 3 and an upper ring abutting from below against the flange 4c of the respective clamping element. Here, the spring mechanism is shown compressed for reasons of clarity, however, the clamping elements 4 are in the upper end position.

Beyond that, FIGS. 3 and 4 show that the top of the tube shaft 3 has a flange 3e that can be connected with a corresponding flange 20 of a rotary drive by a clamping ring 19 in order to rotate the tube shaft 3 and sleeve 1 with respect to a support not is shown here and on which both actuators 13 and 14 are mounted.

A funnel-shaped insert 21 is provided below the tube shaft 3 to make fitting of the drill pipe 9 easier. This insert 21 can be removably mounted on the bottom of the tube shaft 3.

At the lower end of the downwardly flared lower end 1b of the sleeve 1, a brace ring 22 is provided that surrounds the sleeve on the bottom with its upwardly extending outer collar and thus prevents spreading of the sleeve 1 when it is loaded.

FIGS. 6 and 7 show the tube shaft 3 and the sleeve 1 as separate components. In FIG. 7, the sleeve 1 has, in the embodiment that is preferred here, slot[s] 23 in the inner frustoconical surface 1b that extend from the top to the bottom and are uniformly angularly spaced. The slots 23 have flat bases into which guide elements 24 as shown in FIGS. 9 and 10 can be inserted.

These guide elements 24 are of U-section with a flat inner base 24a and edge flanges 24b that are stepped inward at their outer edges so that the guide element 24 forms an undercut slot. Here, the height of the guide elements 24 relative the later positioning in a slot 23, can decrease upward.

The guide element 24 forms a guide track for a respective one of the jaws 2 of the first clamping mechanism that at each side have a groove 2c that extends close to and parallel to the respective outer face 2b. Each slot 2c receives a respective edge flange 24c of the flank 24b of a respective guide element 24, as a result of which the jaw 2 is securely guided in the sleeve. Thus the flat outer face 2b abuts the flat inner base 24a, in particular is such that large forces can be transmitted.

It is to be noted concerning all embodiments that the technical characteristics cited in connection with one embodiment cannot only be used in that specific embodiment or used in such, but also in the other embodiments. All described technical characteristics of this description of the invention and the figures are to be classified as being essential to the invention and can be used in any combination or individually. In the entire disclosure when a characteristic is described as being provided or a method step performed, it is also to be understood as an embodiment of the invention in which the affected characteristic is provided or a pertinent method step is performed.

1. A clamping head for an earth-drilling system having a tube shaft through which a drill pipe can extend, a sleeve coaxially surrounding and shiftable along the tube shaft and having at least one end section that flares downward and frustoconically, the tube shaft or the sleeve supporting at least two jaws radially displaceable with respect to the tube shaft and having, at their radial outer ends, cam faces engageable with the flared end section so that pressing the end section against the jaws shifts them radially inward and forms a first clamping mechanism for a drill pipe so that by mutual engagement of the jaws and the drill pipe a moment of rotation can be transmitted between the tube shaft and the drill pipe wherein a second clamping mechanism is provided in the tube shaft and can axially fix the drill pipe in order to pull a drill pipe axially out of the earth.

2. The clamping head according to claim 1, wherein the second clamping mechanism can be actuated by displacing the sleeve.

3. The clamping head according to claim 1, wherein for actuating the first clamping mechanism by a first actuator, the sleeve is shiftable relative to the tube shaft, and the second clamping mechanism can be actuated by a second actuator that is independent of the first actuator, both actuators bing in particular mounted on a joint support.

4. The clamping head according to claim 1 wherein the second clamping mechanism comprises at least two clamping elements each having a radially outer guide face that is engageable with an inner guide face of the tube shaft, so that displacement of the clamping element axially downward effects radial displacement inward.

5. The clamping head according to claim 4, wherein the clamping elements each have a radially inner frustoconical cam face by means of which they can engage a drill pipe at a shoulder/step formed on an surface of the drill pipe.

6. The clamping head according to claim 4, wherein an inner guide face of the tube shaft is formed by a radially inwardly projecting ring having an inner periphery forming a tapered frustoconical surface that is coaxial to a center axis of the tube shaft and that tapers downward.

7. The clamping head according to claim 6, wherein radially outer guide faces of the clamping elements are complementary to the frustoconical surface (3a) such that engagement between the guide faces increases with increasing engagement between the clamping elements and a drill pipe.

8. The clamping head according to claim 4, wherein the clamping element is displaceable axially on a bolt extending parallel to the tube shaft, the bolt extending through an aperture of the clamping element that is radially elongated or in a radial flange that is located thereon.

9. The clamping head according to claim 4 wherein the clamping elements can be displaced axially by an actuation element mounted inside the tube shaft and being connected with the sleeve by at least one radial bar that extends through an aperture in the tube shaft, the bar being displaceable in an aperture axially of the tube shaft.

10. The clamping head according to claim 9, wherein the actuation element is annular and can simultaneously displace all the clamping elements.

11. The clamping head according to claim 8, wherein the bolts are secured to an actuation element (5) such that the bolts engage in respective guide bores of the ring.

12. The clamping head according to claim 4, wherein a clamping element is displaceable in the direction of increasing engagement against a reset force exerted by a compression spring.

13. The clamping head according to claim 4, wherein the actuation element acts indirectly on a clamping element by at least one compression spring.

14. The clamping head according to claim 13, wherein the compression spring is located between an actuation element and an intermediate ring engaging all the clamping elements simultaneously.

15. The clamping head according to claim 13, wherein the sleeve can be displaced axially relative to the tube shaft first, due to an indirect effect of the actuation element by compression springs, the clamping elements can be pressed into engagement with the drill pipe and, after achieving this engagement between the actuating element and clamping elements or between actuation element and an intermediate ring, an axial range of movement remains due to a free motion in the compression springs, further axial movement in this range of movement being effected by an operative connection, in particular force closure or engagement or frictional connection between the jaws of the first clamping device and a drill pipe.

16. The clamping head according to claim 1, wherein the clamping elements can be displaced axially by at least one annular actuation element mounted inside the tube shaft (3), displaceable in the direction of increasing engagement, the at least one actuation element being connected with a pressure ring surrounding the sleeve by at least one radial bar that extends through an aperture in the tube shaft (3), such that the at least one bar is displaceable in the aperture axially in the tube shaft.

17. The clamping head according to claim 16, wherein the pressure ring is provided in particular with an upper cam face that supports the second actuator by ball or roller bearings.

18. The clamping head according to claim 1, wherein the first actuator (13) a hydraulic cylinder of the first actuator is connected with a ring that surrounds the sleeve and that is supported with respect to tension and compression in both axial directions by ball or roller bearings on a sleeve, the ball or roller bearings being in particular flanked by two collars that surround the sleeve.

19. The clamping head according to claim 12, wherein a resetting force is generated by a compression spring whose one end is supported directly or indirectly by a ring bearing on an inner shoulder of the tube shaft (3) a frustoconical surface and the other end of which is supported directly or indirectly by a ring at a radially overhanging upper section of the clamping element.

20. The clamping head according to claim 1, wherein the clamping elements at their upper ends, are each provided with radial inner tapered frustoconically downward cam faces that in an operative connection with the corresponding cam face located in tube shaft displace a clamping element radially outward during upward movement.

21. The clamping head according to claim 20, wherein cam faces in the tube shaft are formed by a coaxially mounted pipe in the tube shaft whose upper end has an outer, lower frustoconical section.

22. The clamping head according to claim 1, wherein at the lower end of the end section that flares downward, in particular a conically flared section sleeve, an in particular perforated ring is located that houses the tube shaft in its inner periphery and surrounds the end section with a collar that is open upward.

23. The clamping head according to claim 1, wherein the inner surface of the end section of the sleeve that flares downward frustoconically is provided with slots slots extending from the top to the bottom with a flat slot base, in particular in direct or indirect operative connection by an intermediate element with flat cam faces of jaws of the first clamping mechanism.

24. The clamping head according to claim 23, wherein in one of the slots a guide element is mounted, in which a jaw is inserted with its end that has a flat cam face, the guide element in particular being of U-shape with undercut profile brackets.

25. The clamping head according to claim 23 wherein a guide is formed by slots formed in two side surfaces of a jaw in a region that has the end of the cam face parallel to the flat cam face, with which flanges provided at one guide element engage.

26. The clamping head according to claim 1, wherein the jaws of the first clamping mechanism are provided with surfaces that come in operative connection with a drill pipe that has a coating that acts as friction lining.
